(19) United States
(12) Patent Application Publication
(10) Pub. No.: US 2009/0029096 A1
(43) Pub. Date: Jan. 29, 2009

(54) Lay Flat Flooring Products and Methods

(76) Inventor: Dennis L. Riddle, LaGrange, GA (US)

Correspondence Address: Legal Department (M-495), P.O. Box 1926, Spartanburg, SC, 29304, US

(21) Appl. No.: 12/096,138

(22) PCT Filed: Dec. 21, 2006
(86) PCT No.: PCT/US2006/048982

§ 371 Date: Sep. 9, 2008

Related U.S. Application Data
(60) Provisional application No. 60/752,447, filed on Dec. 21, 2005.

(51) Int. Cl. B32B 3/10; B32B 5/00; B32B 33/00; D03D 15/00; D04B 21/02; D04H 1/00; B32B 37/00; B05D 3/02

(52) U.S. Cl. 428/95; 428/195.1; 428/332; 442/181; 442/304; 442/402; 156/307.1; 427/385.5; 427/389.9

(57) ABSTRACT

A surface covering such as a lay flat flooring product having an upper show surface disposed in overlying relation to a single or multi-layer, preferably flexible, heavy, thin, resilient backing. A fibrous backing sheet may be disposed across an underside of the backing. The surface covering may be, for example, a tile or roll goods. The show surface may be a decorative textile or carpet layer.

### TECHNICAL FIELD

The present invention relates to surface coverings such as lay flat flooring products having a show surface in overlying relation to a backing, preferably a flexible, dense, thin, resilient backing. In particular, but not exclusively, the invention relates to a surface covering such as a lay flat flooring, carpet, carpet tile, floor tile, floor covering, floor mat, roll goods, modular product, rug, area rug, mat, runner, broadloom, stabilized broadloom, 6-foot goods, or the like. The surface covering may incorporate, for example, a tufted, bonded, flocked, needled, knit, woven, or non-woven decorative carpet or textile face or surface layer. The textile or carpet face and the backing will generally be bonded together during product manufacture. An optional stabilizing layer and/or textile backing layer may be incorporated above, in, or below the backing. Friction enhancing, adhesive, or installation facilitating coatings, treatments or materials may be added to and/or on the underside of the backing. For example, materials which increase lateral grip, reduce creep, and the like. Methods of making such lay flat surface coverings are also provided.

Carpet or floor tiles are expected to lie flat. Complex constructions, process variations, and environmental conditions of end-use installations may all contribute to variations in tile flatness. It is at least one objective of at least one embodiment of the present invention to create a product and process from robust design parameters such that flatness is preferably dominated by gravitational forces rather than process variations or environmental challenges. It is further expected that added functionality may be optionally included in the carpet product.

Traditional carpet tile designs have relied upon either two separated stabilizing layers or a single stabilizing layer and added forces to maintain flatness. Two separated stabilizing layers create an I-beam effect yielding a relatively high modulus to resist bending. Alternatively, the single stabilizing layer and added forces on both sides tend to balance around the neutral axis. Both approaches result in a relatively stiff, thick structure.

For example, Milliken & Company sold a first generation polyurethane cushion back carpet tile product under the name Comfort Plus® that had two stabilizing layers and a balancing layer.

U.S. Pat. No. 4,522,857 hereby fully incorporated by reference herein shows an early version of Milliken & Company's first generation Comfort Plus® tile product.

U.S. Pat. No. 5,204,155 hereby fully incorporated by reference herein shows a carpet or carpet tile with two spaced apart stabilizing layers in the backing.

U.S. Pat. Nos. 5,540,968; 5,545,276; 5,948,500; 6,203,881; and 6,468,623 each hereby fully incorporated by reference herein show Milliken & Company's second generation Comfort Plus® tile product having a single stabilizing layer and a balancing layer.

U.S. Pat. No. 6,162,309 hereby fully incorporated by reference herein shows a carpet tile or roll product having a single reinforcing scrim.

U.S. Pat. No. 4,915,999 hereby fully incorporated by reference herein shows a carpet product with a single stabilizing layer and a balancing layer.

At least one purpose of at least one embodiment of the present invention is to design out the forces to their minimums so that gravitational forces dominate processing, environmental and other forces. This creates, for example, a carpet or floor tile or roll goods structure that hugs the surface upon which it is laid (lay flat tile, lay flat flooring). Also, enhanced flammability performance can be achieved with the proper selection of raw materials. Further, with the choice of those same materials, it is possible to switch-on magnetic properties for use with metal raised panel floors, metal cruise ship decks, and other ferromagnetic surfaces.

Although carpet tiles have been made for well over 30 years, there are still issues with tile flatness. It has been discovered that spikes of very high tension (e.g., 8,000 lbs per 75 inches width) have a strong correlation to latent curling, particularly at low humidity conditions. The thermal effects in the life of a tile process or production cycle were also found significant to the short and long term stability of the tiles. Significant adjustments to the current process specifications may prove successful in stabilizing the resultant tile products.

At least certain embodiments of the present invention are directed to redesign of the product construction.

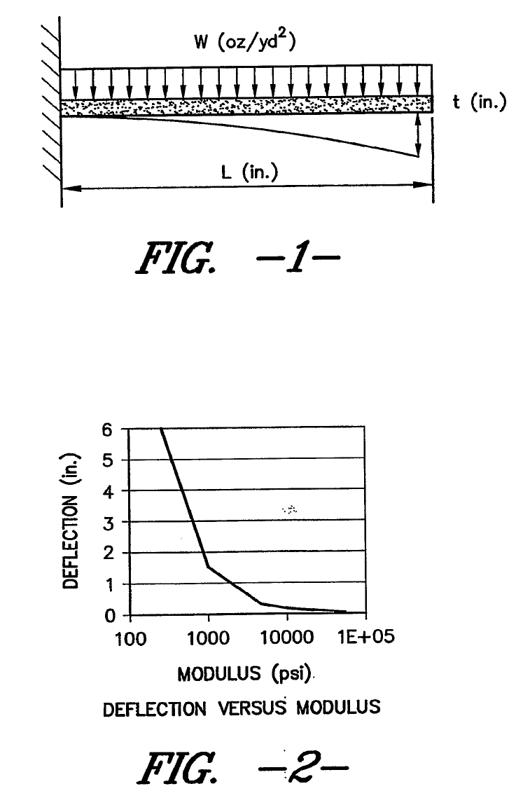

FIG. 1 is a schematic side view of a cantilever beam.

FIG. 2 is a graphical representation of Deflection versus Modulus.

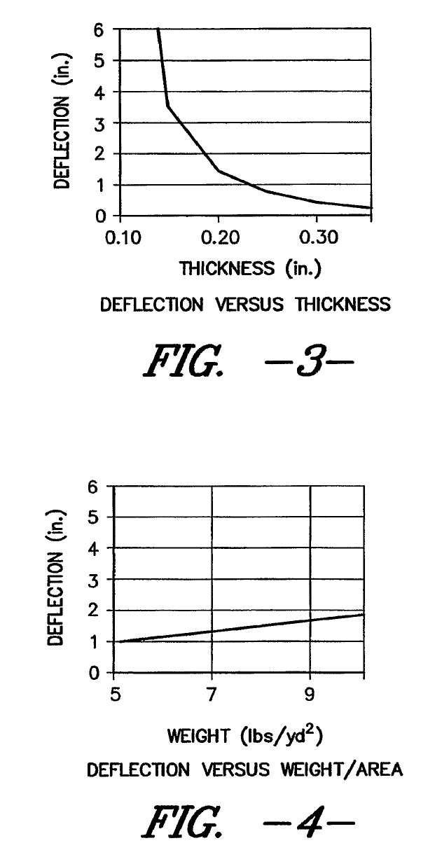

FIG. 3 is a graphical representation of Deflection versus Thickness.

FIG. 4 is a graphical representation of Deflection versus Weight per Area.

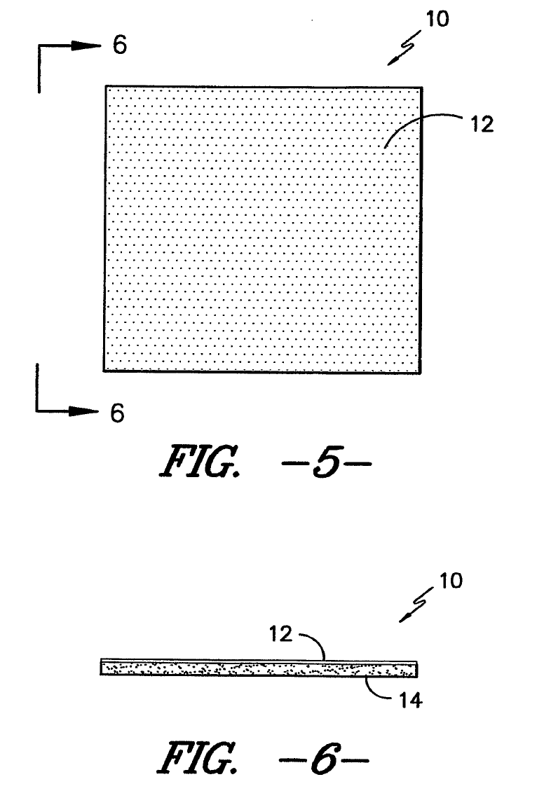

FIG. 5 is a schematic top plan view of a surface covering such as a lay flat flooring product incorporating a decorative show surface and a backing.

FIG. 6 is a schematic elevation side view or end view taken along line 6-6 in FIG. 5.

In accordance with at least one aspect of the present invention, I chose to look at tile from the product point of view and to model the potential physical properties that ensure flatness or conversely that drive instability, such as cup or curl. I began by developing a system of non-linear differential equations to describe the mechanical and thermal effects of the tile formation process, post processing, and environmental conditions. I came to the belief that I could model directional influences through a simple analogy of a cantilever beam (see FIG. 1).

Further consideration of this approach led me to my first principle of tile design: Gravity forces should dominate the sum of other process induced forces. Examples of these other forces are the aforementioned tensions or thermal contractions from cooling.

Let us begin by studying the gravity model on a cantilever beam (FIG. 1).

$${δ}_{B} = \frac{{qL}^{4}}{8 EI} \qquad Eqn . 1$$

This can be simplified for carpet tile applications by:

$${δ}_{B} = \frac{{WL}^{4}}{864 {Et}^{3}} \qquad Eqn . 2$$

Where:

W=the carpet weight (lbs/yd²)

L=Length of overhang (use 6″ as a constant)

E=Young's Modulus (σ/ε) for the composite

t=the bound thickness (in.)—do not include the pile height

δ=the maximum deflection of the beam (in.)

We can measure the weight (W), deflection (in.), and thickness (in.) in order to calculate the modulus (psi or pounds per square inch).

Assume W is held constant at 8 lbs/yd² (or 128 oz/yd²). Further assume t is held constant at 0.20 in. We can then see (FIG. 2) the relationship between δ and E. If we now hold the Modulus constant (e.g., E=1,000 psi), we can illustrate (FIG. 3) the relationship between δ and t.

Finally, we can hold thickness and modulus constant and illustrate (FIG. 4) the relationship of δ and W.

Note that in each of these examples the equations assume that the angle of deflection is small such that the trigonometric approximation of sin(Y)=Y. In our case, we want large deflections, so these become qualitative rather than quantitative figures.

Studying the figures (FIGS. 1-4), we see that in accordance with at least one aspect of the present invention, we want to increase weight, reduce thickness, and reduce modulus of the composite. Although heavier may be intuitive, the combination of thin and heavy is not, and requires that the backing materials are characterized by higher density. This may be achieved by the selection of dense raw materials such as dense fillers. For example, CaCO₃ is a common filler used in floor covering products. It has a specific gravity (SG) of 2.6. If a filler is selected with a SG greater than 5 and the concentration by weight remained the same (>50%), then a significant shift in the compound density would occur. If the choice was Iron (Fe) with a SG of 7.8 and with a concentration of 70%, then the density could be nearly tripled resulting in a ⅔ reduction in thickness at the same backing weight.

If a ferromagnetic material is selected as the filler, it creates the option of selectively creating permanent magnetic properties in the backing. A magnetron located on or after the production range could be switched on/off to produce the optional magnetic property. If the ferromagnetic material is an oxide, such as ferrite, then the material will not only be dense and magnetizable, but will also starve a fire event from oxygen and self extinguish.

With reference to FIGS. 5 and 6 of the drawings, an exemplary surface covering 10 such as a lay flat flooring product or tile has an upper show surface 12 and a backing 14. It is preferred that the show surface 12 such as a carpet or textile material be bonded to the backing 14 during manufacture of the surface covering 10. Backing 14 preferably has a very low bending modulus (very flexible), a high density, is thin, and is resilient. Flexibility (low modulus) and high density (heavy) may be the two most important factors that effect tile flatness.

The face or upper show surface 12 is preferably an aesthetically pleasing carpet or textile material. For example, a graphics tufted, printed, dyed, or the like decorative carpet or textile (tufted, woven, bonded, nonwoven, flocked, needled, knit, or the like) of natural and/or synthetic fibers such as wool, polyamide (Nylon), polyester, polyolefin, blends, and the like.

Preferably, the face 12 exits the manufacturing process with substantially zero tension and resists growth or shrinkage during product use.

Although FIGS. 5 and 6 depict a square shape, it is contemplated that the lay flat product 10 may be any desired shape and may be in the form of roll goods, modular product, 6-foot broadloom, 12-foot broadloom, carpet, carpet tile, flooring, floor tile, floor covering, floor mat, stabilized broadloom, rug, runner, or the like. For example, a 6-foot wide roll of lay flat composite may be cut into tiles, rugs, mats, runners, and/or the like. The face 12 is not limited to a precoated carpet or greige goods (non-precoated) face material although such a face may be preferred. Also, it may be possibly preferred that the face 12 be range dyed get dyed) prior to lamination or backing to further reduce any latent stresses or tensions in the face. Further, lamination or backing of the face 12 may be carried out at a low enough temperature and the face material or materials (for example, primary backing and tufts) may be selected to avoid the addition of stresses or instability (such as shrinkage) during processing, backing, lamination, curing, etc.

In accordance with possibly preferred embodiments, the backing 14 includes one or more stabilizing layers, backing layers, foam or cushion layers, a friction enhancing coating, magnetic or magnetizable particles, remains flexible at standard operating temperatures, and/or the like. In accordance with one example, the backing 14 is a thin (less than about 5 mm, preferably less than about 3 mm), very flexible, dense, resilient, polymeric material.

In accordance with one example, face 12 is a jet dyed, tufted, polyamide (Nylon) 6 or 6,6 carpet face with a stable primary backing of, for example, woven and/or nonwoven polyamide (Nylon), polyester, and/or stabilized polypropylene.

It may be preferred that the carpet face 12 has a tuft lock or precoat of the same material as backing 14, for example, a polyurethane precoat and a polyurethane backing.

In accordance with another example, a hardback floor tile has a flexible, heavy (dense), thin backing with the following preferred properties:
1. backing density—about 180 to 250 lbs/ft³ (3-4 g/cc)
2. backing thickness—about 0.15 inch
3. tile drape—about 2 to 4 inches of drape on a 6 inch tile overhang

In accordance with at least selected embodiments of other aspects of the present invention, it may be preferred:
1. To use an adhesive to join a greige tufted substrate to a polyurethane (PU) cushion structure that provides above average wet and dry tuft bind, and PU lamination strength greater than the cohesion of the PU cushion.
   1.1. Adhesive Physical Properties
      1.1.1. High flexibility, low modulus (<3,000 psi)
      1.1.2. non-PVC, non-latex
      1.1.3. composite cuts easily with standard carpet knife
      1.1.4. resin may be an aqueous emulsion, hot melt, or multipart reaction applied with a coating blade, film lamination, or in-situ extrusion at speeds greater than 50 fpm (feet per minute).
   1.2. The adhesive should provide a moisture barrier in the composite structure.
   1.3. The adhesive may optionally contain recycled content.
      1.3.1. >50% recycled content
      1.3.2. preferably post consumer recycled content
   1.4. The adhesive may optionally provide enhanced flammability resistance to meet vertical flammability tests.
      1.4.1. IMO certification (cruise ships)
   1.5. The adhesive may become an after life cycle “zipper” to separate the tufted substrate from the PU cushion structure.
      1.5.1. zipper may be thermal
      1.5.2. zipper may be mechanical
      1.5.3. zipper may be chemical
   1.6. The adhesive used above should be commercially competitive.
2. The composite using the adhesive can be recycled into item 1.3 or into the PU cushion.
   2.1. Rather than separating components, carpet composite may be desized and integrated into the filler integral to the adhesive.
3. The PU cushion structure may be substituted with another cushion material that:
   3.1. Provides economic advantage.
   3.2. Enables an economically viable recyclable composite.
   3.3. Possibly Needled Felt
   3.4. Possibly resized end of life (EOL) carpet with binder
4. The PU cushion structure may be substituted with another material that:
   4.1. Creates an optional hardback using the same (or expanded) capital investments for the adhesive from item 1.
   4.2. Utilizes recycled content.
   4.3. Provides a clear EOL recycling process.
   4.4. Provides an economic advantage over competitive hardback.
   4.5. Standard carpet knives easily cut the composite.
5. The aforementioned options may create improved products.

In accordance with at least certain other embodiments of other aspects of the present invention, it may be preferred:

1. To use an adhesive to join a greige tufted substrate to a polyurethane (PU) cushion structure that provides above average wet and dry tuft bind, and PU lamination strength greater than the cohesion of the PU cushion.
1.1. The adhesive may provide a moisture barrier in the composite structure.
1.2. The adhesive may optionally contain recycled content.
1.3. The adhesive may optionally provide enhanced flammability resistance to meet vertical flammability tests.
1.4. The adhesive may become an after life cycle “zipper” to separate the tufted substrate from the PU cushion structure.
1.5. The adhesive should be commercially competitive.

2. The composite using the adhesive can be recycled into item 1.2.

3. The PU cushion structure may be substituted with another material that:
3.1. Provides economic advantage.
3.2. Enables an economically viable recyclable composite.

4. The PU cushion structure may be substituted with another material that:
4.1. Creates an optional hardback using the same (or expanded) capital investments for the adhesive from item 1.
4.2. U EV824804738UStilizes recycled content.
4.3. Provides a clear recycling process.
4.4. Provides an economic advantage over competitive hardback.

5. The aforementioned options may create improved products.

6. The aforementioned options should meet customer expectations of fitness for use including installation.

In accordance with yet another example, a lay flat flooring product has a backing that is flexible, dense, thin, and resilient,
flexible—product drape greater than about 2 inches of drape on a 6-inch product overhang or a bending modulus less than about 2000 psi;
dense—backing density of greater than about 20 lbs/ft³;
thin—backing height (thickness) of less than about 10 mm;
resilient—product can be rolled or folded at least once and will go back to a lay flat position.

In accordance with still another example, a lay flat hardback flooring product has a backing that is flexible, dense, thin, and resilient,
flexible—product drape greater than about 3 inches of drape on a 6-inch product overhang or a bending modulus less than about 1000 psi;
dense—backing density of greater than about 50 lbs/ft³;
thin—backing height (thickness) of less than about 5 mm;
resilient—product can be rolled or folded several times and will go back to a lay flat position.

In accordance with still another example, a lay flat cushion back flooring product has a backing that is flexible, dense, thin, and resilient,
flexible—product drape greater than about 2 inches of drape on a 6-inch product overhang or a bending modulus less than about 3000 psi;
dense—backing density of greater than about 15 lbs/ft³;
thin—backing height (thickness) of less than about 15 mm;
resilient—product can be rolled or folded at least once and will go back to a lay flat position.

In accordance with a possibly preferred example, a lay flat hardback flooring product has a backing that is flexible, dense, thin, and resilient,
flexible—product drape greater than about 4 inches of drape on a 6-inch product overhang or a bending modulus less than about 500 psi;
dense—backing density of greater than about 200 lbs/ft³;
thin—backing height (thickness) of less than about 3 mm;
resilient—product can be rolled or folded many times and will go back to a lay flat position.

In accordance with yet another example, a lay flat carpet tile product has a backing that is flexible, dense, thin, and resilient,
flexible—product drape greater than about 2 inches of drape on a 6-inch product overhang;
dense—backing density of greater than about 25 lbs/ft³;
thin—backing height (thickness) of less than about 5 mm;
resilient—product can be rolled or folded at least once and will go back to a lay flat position.

In accordance with still another example, a lay flat roll goods product has a backing that is flexible, dense, thin, and resilient,
flexible—product drape greater than about 4 inches of drape on a 6-inch product overhang;
dense—backing density of greater than about 100 lbs/ft³;
thin—backing height (thickness) of less than about 5 mm;
resilient—product can be rolled or folded several times and will go back to a lay flat position.

In accordance with yet another example, a lay flat floor mat product has a backing that is flexible, dense, thin, and resilient,
flexible—product drape greater than about 2 inches of drape on a 6-inch product overhang;
dense—backing density of greater than about 50 lbs/ft³;
thin—backing height (thickness) of less than about 5 mm;
resilient—product can be rolled or folded at least once and will go back to a lay flat position.

In accordance with a possibly preferred embodiment, a lay flat flooring product includes a face material and a backing bonded thereto during product manufacture.

In accordance with another example, a lay flat flooring product is a laminated composite of a face, a backing, and an adhesive layer therebetween. The adhesive may be the same material as the backing, may be less filled or unfilled, or may be of a different material. Preferably, the adhesive is flexible, resilient, and thin.

In accordance with one object of the present invention, there is provided a lay flat flooring product comprising an upper show surface disposed in overlying relation to a single or multi-layer, flexible, heavy, thin backing, said backing having at least one of a bending modulus of less than about 3,000 psi, a thickness of less than about 15 mm, and a density of greater than about 15 lbs/ft³.

In accordance with yet another object of the present invention, there is provided a method of producing a lay flat flooring product such as a lay flat tile or roll goods product with a carpet or textile face and a flexible, heavy, think, resilient backing, comprising the steps of: preparing a backing composition; depositing the backing composition in a layer; placing a carpet or textile face material on the deposited backing layer to form a multi-layer structure; setting or curing the backing so that the backing composition forms a flexible, heavy, thin, resilient backing, and wherein the carpet or textile face material is bonded to the backing.

In accordance with at least one embodiment, a surface covering such as a lay flat flooring product comprises an upper show surface disposed in overlying relation to a single or multi-layer, flexible, heavy, thin backing.

The surface covering above further comprising a fibrous backing sheet disposed across an underside portion of the backing.

The surface covering above, wherein the surface covering is a tile or roll goods.

The surface covering above, wherein the show surface is a decorative textile or carpet layer.

The surface covering above, wherein the carpet or textile is formed of polyester, Nylon, polyolefin, and combinations thereof.

The surface covering above, wherein the carpet or textile is knit, woven, tufted, bonded, nonwoven, needled, and the like.

The surface covering above, wherein the backing is resilient.

The surface covering above, wherein the show surface is disposed in overlying relation to a multi-layer backing.

The surface covering above, wherein the backing includes at least one stabilizing layer.

The surface covering above, wherein said stabilizing layer is at least one of woven or nonwoven glass.

The surface covering above, further comprising a fibrous backing sheet disposed across an underside portion of the backing.

In accordance with at least one embodiment, a method of producing a surface covering such as a lay flat flooring product with a carpet or textile surface and a flexible, heavy, thin, resilient backing, comprises the steps of: preparing a backing composition; depositing the backing composition in a layer; placing a carpet or textile surface material on the deposited backing layer to form a multi-layer structure; pressing the multi-layer structure while setting the backing with, for example, heat so that the backing composition forms a flexible, heavy, thin, resilient backing, and wherein the carpet or textile surface material is bonded to the backing.

The method above wherein the carpet or textile surface material is at least one of graphics tufted, printed or dyed.

The method above wherein one or more additional layers are added in, over or under the backing composition layer.

In at least one embodiment, there is provided a surface covering such as a lay flat flooring product having an upper show surface disposed in overlying relation to a single or multi-layer, flexible, heavy, thin, resilient backing. A fibrous backing sheet may be disposed across an underside of the backing. The surface covering may be a tile or roll goods. The show surface may be a decorative textile or carpet layer.

In accordance with at least one example, a lay flat flooring product comprises an upper show surface disposed in overlying relation to a single or multi-layer, flexible, heavy, thin backing, said backing having at least one of a bending modulus of less than about 3,000 psi, a thickness of less than about 15 mm, and a density of greater than about 15 lbs/ft³.

The product above further comprises a flexible fibrous backing sheet disposed at a position below an underside of the backing.

The product above, wherein the flooring product is one of a tile and roll goods.

The product above, wherein the show surface is a decorative textile or carpet layer.

The product above, wherein the show surface is formed of a material selected from polyester, polyamide (Nylon), polyolefin, and combinations thereof.

The product above, wherein the show surface is one of knit, woven, tufted, bonded, nonwoven, needled, graphics tufted, printed, dyed, and combinations thereof.

The product above, wherein the backing is resilient.

The product above, wherein the show surface is disposed in overlying relation to a multi-layer backing.

The product above, wherein the backing includes at least one stabilizing layer.

The product above, wherein said stabilizing layer is at least one of woven or nonwoven glass.

The product above, wherein said backing has a bending modulus of less than about 3,000 psi, a thickness of less than about 15 mm, and a density of greater than about 15 lbs/ft³.

The product above, wherein said backing preferably has a bending modulus of less than about 2,000 psi, a thickness of less than about 10 mm, and a density of greater than about 20 lbs/ft³.

The product above, wherein said backing has a bending modulus of less than about 1,000 psi, a thickness of less than about 5 mm, and a density of greater than about 50 lbs/ft³.

The product above, wherein said backing has a bending modulus of less than about 1,000 psi, a thickness of less than about 4 mm, and a density of greater than about 100 lbs/ft³.

The product above, wherein said backing has a bending modulus of less than about 500 psi, a thickness of less than about 3 mm, and a density of greater than about 200 lbs/ft³.

In accordance with at least one embodiment, a method of producing a lay flat flooring product such as a lay flat tile or roll goods product with a carpet or textile face and a flexible, heavy, thin, resilient backing, comprising the steps of: preparing a backing composition; depositing the backing composition in a layer; placing a carpet or textile face material on the deposited backing layer to form a multi-layer structure; setting or curing the backing so that the backing composition forms a flexible, heavy, thin, resilient backing, and wherein the carpet or textile face material is bonded to the backing.

The method above wherein the carpet or textile face material is at least one of graphics tufted, printed or dyed.

The method above further comprising the step of adding one or more additional layers in, over or under the backing composition.

In accordance with at least one embodiment, a method of producing a lay flat flooring product such as a lay flat tile or roll goods product with a carpet or textile face, and a flexible, heavy, thin, resilient backing, comprising the steps of: preparing a backing composition; inverting a carpet or textile face material; depositing the backing composition on the inverted face material to form a multi-layer structure; setting or curing the backing so that the backing composition forms a flexible, heavy, thin, resilient backing, and wherein the carpet or textile face material is bonded to the backing.

The method above, wherein the carpet or textile face material is at least one of graphics tufted, printed, and dyed.

The method above further comprising the step of adding one or more additional layers in, over or under the backing composition layer.

A lay flat flooring product produced by one of the methods above.

In accordance with at least selected examples, the preferred backing is filled polyurethane (greater than 50% by weight filled). Although less preferred, other materials which will provide a relatively heavy, thin, flexible, and resilient backing may be used. For example, rubber, latex, extruded polymers, hot melts, adhesives, films, acrylics, and the like may be used.

In accordance with at least selected examples, the preferred adhesive is an unfilled or lightly filled polyurethane (less than 20% by weight filled). Although polyurethane adhesive is preferred, other known adhesives may be used. For example, hot melts, polymers, polyolefins, extruded polymers, acrylics, or the like.

In accordance with at least selected examples, the preferred fillers are dense fillers having, for example, a specific gravity (SG) greater than 2. Exemplary fillers include magnetite, iron oxides, ferrite, iron, steel, nickel, metals, recycled metals, barite, sand, foundry sand, used foundry sand, glass, recycled glass, recycled soda lime glass, glass particles, glass fibers, gypsum, recycled gypsum, coal fly ash, calcium carbonate, blends and combinations thereof. Fillers are typically added in amounts by weight totaling from 0% to about 95%.

In accordance with at least one embodiment, fillers with a specific gravity (5G) over 5 are preferred (such as iron oxide).

In accordance with at least one other embodiment, magnetic or magnetizable filler materials are preferred. Such ferromagnetic fillers may be added at 5% by weight or greater filler loads, preferably 10% or greater by weight.

In accordance with at least one example, a method of producing a lay flat product includes the steps of:
1. Producing a substantially tensionless face;
2. Treating the face to remove stresses;
3. Laminating or backing the face;
4. Selectively magnetizing the composite; and
5. Rolling or cutting the composite to form lay flat products.

While the present invention has been illustrated and described in relation to certain potentially preferred embodiments and practices, it is to be understood that the illustrated and described embodiments and practices are illustrative only and that the present invention is not to be limited thereto. Rather, it is fully contemplated that modifications and variations to the present invention will no doubt occur to those of skill in the art upon reading the above description and/or through practice of the invention. It is therefore intended that the present invention shall extend to all such modifications and variations as may incorporate the broad aspects of the present invention within the full spirit and scope of the following claims and all equivalents thereto.

The words “comprises/comprising” and the words “having/including” when used herein with reference to the present invention are used to specify the presence of stated features, integers, steps or components but does not preclude the presence or addition of one or more other features, integers, steps, components or groups thereof.

It is appreciated that certain features of the invention, which, for clarity, are described in the context of separate embodiments, may also be provided in combination in a single embodiment. Conversely, various features of the invention which are, for brevity, described in the context of a single embodiment, may also be provided separately or in any suitable sub-combination.

1. A lay flat flooring product comprising an upper show surface disposed in overlying relation to a single or multi-layer, flexible, heavy, thin backing, said backing having at least one of a bending modulus of less than about 3,000 psi, a thickness of less than about 15 mm, and a density of greater than about 15 lbs/ft³.

2. The invention of claim 1, further comprising a flexible fibrous backing sheet disposed at a position below an underside of the backing.

3. The invention of claim 1, wherein the flooring product is one of a tile and roll goods.

4. The invention of claim 1, wherein the show surface is one of a decorative textile and a carpet layer.

5. The invention of claim 4, wherein the show surface is formed of a material selected from polyester, polyamide (Nylon), polyolefin, blends, and combinations thereof.

6. The invention of claim 4, wherein the show surface is one of knit, woven, tufted, bonded, nonwoven, needled, flocked, graphics tufted, printed, dyed, and combinations thereof.

7. The invention of claim 1, wherein the backing is at least one of resilient, flexible, and formed of polyurethane.

8. The invention of claim 1, wherein the show surface is disposed in overlying relation to a multi-layer backing.

9. The invention of claim 8, wherein the backing includes at least one stabilizing layer.

10. The invention of claim 9, wherein said stabilizing layer is at least one of woven or nonwoven glass.

11. The invention of claim 1, wherein said backing has a bending modulus of less than about 3,000 psi, a thickness of less than about 15 mm, and a density of greater than about 15 lbs/ft³.

12. The invention of claim 1, wherein said backing has a bending modulus of less than about 2,000 psi, a thickness of less than about 10 mm, and a density of greater than about 20 lbs/ft³.

13. The invention of claim 1, wherein said backing has a bending modulus of less than about 1,000 psi, a thickness of less than about 5 mm, and a density of greater than about 50 lbs/ft³.

14. A method of producing a lay flat flooring product such as a lay flat tile or roll goods product with a carpet or textile face and a flexible, heavy, thin, resilient backing, comprising the steps of: preparing a backing composition; depositing the backing composition in a layer; placing a carpet or textile face material on the deposited backing layer to form a multi-layer structure; setting or curing the backing so that the backing composition forms a flexible, heavy, thin, resilient backing, and wherein the carpet or textile face material is bonded to the backing.

15. The method of claim 14, wherein the carpet or textile face material is at least one of knit, woven, tufted, bonded, nonwoven, needled, flocked, graphics tufted, printed, dyed, and combinations thereof.

16. The method of claim 14, further comprising the step of adding one or more additional layers in, over or under the backing composition layer.

17. A method of producing a lay flat flooring product such as a lay flat tile or roll goods product with a carpet or textile face and a flexible, heavy, thin, resilient backing, comprising the steps of: preparing a backing composition; inverting a carpet or textile face material; depositing the backing composition on the inverted face material to form a multi-layer structure; setting or curing the backing so that the backing composition forms a flexible, heavy, thin, resilient backing, and wherein the carpet or textile face material is bonded to the backing.

18. The method of claim 17, wherein the carpet or textile face material is at least one of knit, woven, tufted, bonded, nonwoven, needled, flocked, graphics tufted, printed, dyed, and combinations thereof.

19. The method of claim 17, further comprising the step of adding one or more additional layers in, over or under the backing composition layer.

20. (canceled)

21. The method of claim 14, wherein the backing composition is a polyurethane.

22. The method of claim 17, wherein the backing composition is a polyurethane.

23. A lay flat flooring product produced by the method of claim 14.

24. A lay flat flooring product produced by the method of claim 17.
